(19) United States
(12) Patent Application Publication
(10) Pub. No.: US 2005/0190563 A1
(43) Pub. Date: Sep. 1, 2005

(54) Lighting module with dual-profiled Fresnel lens

(76) Inventors: Ying Hung Li, Kowloon (HK); Ashley Min Hang Pun, Kowloon (HK); Chi Choy Wong, Kowloon (HK); Sin Wing Chan, Kowloon (HK); Derek Chi Hang Louie, Kowloon (HK); Li Man Li, Kowloon (HK)

Correspondence Address: ALIX YALE & RISTAS LLP, 750 MAIN STREET, SUITE 1400, HARTFORD, CT, 06103, US

(21) Appl. No.: 10/787,400

(22) Filed: Feb. 26, 2004

(51) Int. Cl. F21V 5/00

(52) U.S. Cl. 362/332; 362/326

(57) ABSTRACT

A lighting module employs a Fresnel lens having concentric regions of different focal lengths. The light source is positioned at the focal distance of a central lens region and inside the focal distance of a peripheral lens region. The resulting light pattern is a bright central spot surrounded by a ring of diminishing brightness.

### FIELD OF THE INVENTION

The invention relates to illumination devices and more particularly to a simplified lighting module employing a single light source and Fresnel lens.

### DESCRIPTION OF THE RELATED ART

Combinations of reflectors and lenses are commonly employed for gathering, focusing and directing light from one or more light emitters into a pattern useful for a particular use. The most common arrangement is a light emitter arranged in front of a curved reflector where the reflector redirects light from the light source to provide a directional light source. Frequently, the directional light is directed through a lens configured to focus or disperse the directional light in a desired pattern. Light-focusing lenses are most useful in applications requiring high-intensity light while light spreading or dispersing arrangements are generally applicable to illumination or warning applications.

### SUMMARY OF THE INVENTION

Briefly stated, the invention employs a dual-profile Fresnel lens in combination with an LED light source to provide a versatile lighting module. The LED light source is essentially a directional light source and, therefore, does not require a reflector. The Fresnel lens includes a central region having a first focal length surrounded by a peripheral region having a second longer focal length. The peripheral region of the Fresnel lens redirects light at the periphery of the LED light emission pattern to a focused but still diverging pattern. The central portion of the Fresnel lens is provided with a focal length calculated to collimate light from the LED. By “collimate”, this application intends to describe redirecting (straightening) divergent light from the central portion of the LED light emission pattern into a direction parallel to an optical axis of the LED.

When a lighting module according to aspects of the present invention is directed at an object, it produces a bright central region surrounded by a less intensely lit outer ring. This light-emission pattern is useful not only for close work requiring relatively intense light but also for area illumination applications where a wider pattern of less intense light is useful. Simplicity and ease of construction characterize the illumination module. Further, the flat Fresnel lens is very durable and takes up little room. An appropriate Fresnel lens can be molded from optically transmissive plastic and is, therefore, inexpensive to produce.

An aspect of the invention relates to a particular configuration for the Fresnel lens. The Fresnel lens outside surface (facing away from the light source) is configured as a substantially planar surface. Such a surface is easily cleaned and will not tend to gather dirt or other materials that interfere with light transmission. The light-refracting Fresnel lens features are formed on the inside surface of the lens (facing the light source). These delicate, concentric rings of the Fresnel lens pattern may be protected by surrounding the lighting module with a housing or the like.

### BRIEF DESCRIPTION OF THE DRAWINGS

FIG. 1 is a side sectional view through a lighting module according to aspects of the present invention;

FIG. 2 is a schematic representation of a dual-profile Fresnel lens according to aspects of the present invention; and

FIG. 3 illustrates the light pattern produced by a lighting module according to aspects of the present invention.

### DETAILED DESCRIPTION OF THE PREFERRED EMBODIMENT

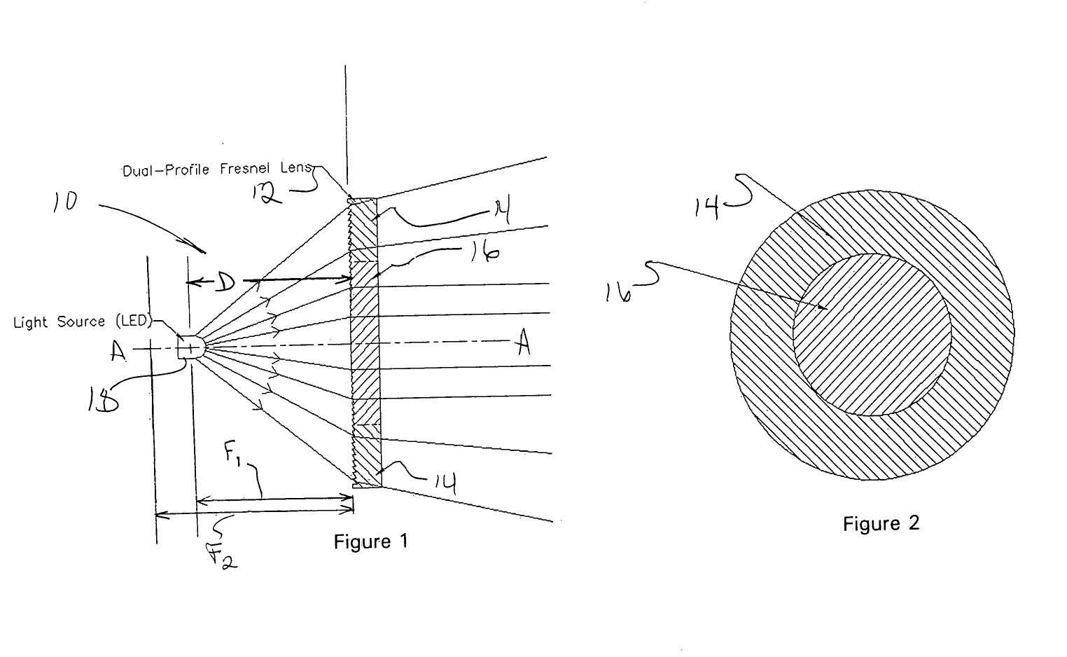

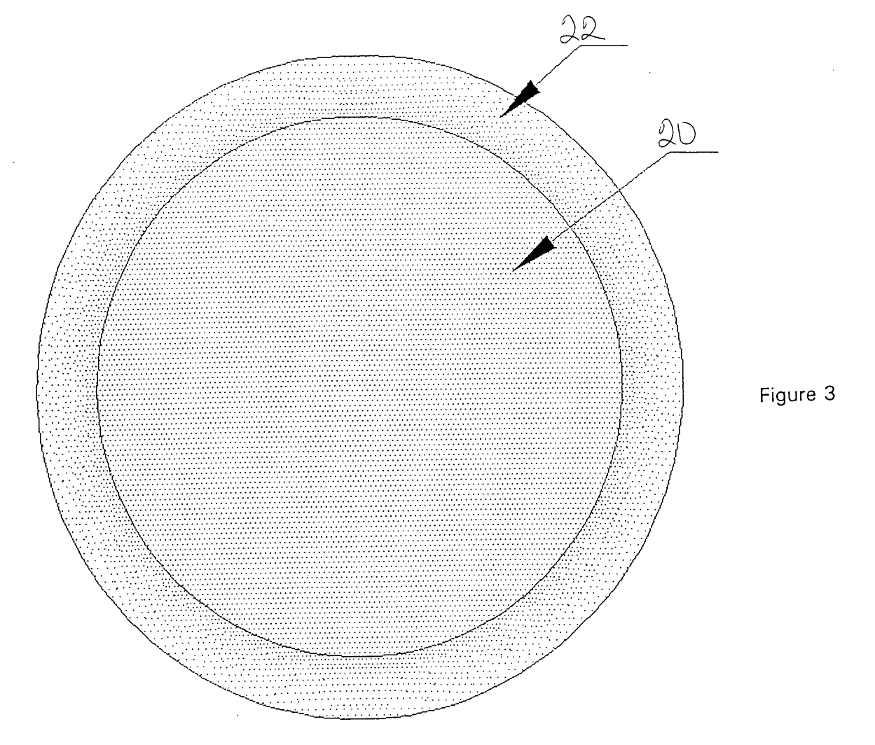

An exemplary embodiment of a lighting module according to aspects of the present invention will now be described with reference to FIGS. 1-3. In its most basic form, a lighting module 10 according to the present invention includes a light source 18 and a Fresnel lens 12 having concentric regions of differing focal length. These regions are illustrated in FIGS. 1 and 2 as 16 in the center of the Fresnel lens and 14 at the periphery of the Fresnel lens. The horizontal lines in FIG. 1 marking the transition from surface features having a first focal length F₁ to surface features having a focal length F₂ are for purposes of illustration only. The different focal lengths F₁, F₂ of the lens portions 16, 14 are related to the shape and angular orientation of the lens surface features as well as the refractive power of the lens material relative to the refractive power of the surrounding air.

According to an aspect of the present invention, the focal length F₂ of the outer Fresnel lens portion 14 is longer than the focal length F₁ of the central Fresnel lens portion 16. The light source 18 is positioned at the focal length F₁ of the central Fresnel lens portion 16. Divergent light from the light source 18 is collimated by the central Fresnel lens as shown in FIG. 1. The light source 18 is positioned somewhat out of focus for the outer Fresnel lens portion 14, so that light at the periphery of the LED emission pattern is refracted into a slightly diverging pattern as shown in FIG. 1.

A preferred light source for the lighting module 10 is a light-emitting diode (LED). LEDs are essentially directional light sources emitting light from a silicon die encapsulated in light transmissive plastic. The die typically rests on an internal reflector such that light is emitted in a directional diverging pattern along an optical axis A of the LED. A majority of the light from the LED is emitted within a small angle relative to the optical axis A. For the illustrated lighting module 10, this narrow-angle light is incident upon and collimated by the central Fresnel lens portion 16. Wider-angle light is redirected but not collimated by the outer Fresnel lens portion 14. FIG. 3 illustrates the light pattern produced by the illustrated lighting module. Collimated narrow-angle light produces a bright spot 20 in FIG. 3. The bright central spot 20 is surrounded by a region of gradually diminishing brightness 22 in FIG. 3.

The diameter of the illustrated dual profile Fresnel lens is approximately 14 mm, with approximately the center 8 mm occupied by lens features producing the first focal length F₁. The first focal length F₁ is approximately 12 mm, while the second focal length F₂ is approximately 19 mm. The lens thickness is approximately 1-2 mm. For this embodiment, the light source 18 is placed a distance D of between 5 mm and 15 mm from the Fresnel lens 12. Light from the light source 18 is more tightly collimated by the central portion 16 of the Fresnel lens 12 than the peripheral portion 14, producing the light pattern shown in FIG. 3.

While an illustrated embodiment of the foregoing invention has been set forth for purposes of discussion, the foregoing description should not be deemed a limitation of the invention herein. Accordingly, various modifications, adaptations and alternatives may occur to one skilled in the art without departing from the spirit and the scope of the present invention.

1. A lighting module comprising:
a light source which emits divergent directional light around an optical axis A; and
a Fresnel lens having a central portion with a first focal length F₁ surrounded by a peripheral Fresnel lens portion having a second focal length F₂, said second focal length being greater than said first focal length,
wherein said light source is arranged a distance D from said Fresnel lens with the optical axis A of the light source perpendicular to and centered on said Fresnel lens, said distance D being equal to or greater than said first focal length F₁ and less than or equal to said second focal distance F₂.

2. The lighting module of claim 1, wherein said Fresnel lens has an inside surface facing said light source defining Fresnel lens features and an axially opposed outside surface that is substantially planar.

3. The lighting module of claim 1, wherein said light source is an LED.

4. The lighting module of claim 1, wherein said first and second Fresnel lens portions are integrally molded at the same time.
